(19) United States
(12) Patent Application Publication
(10) Pub. No.: US 2023/0173718 A1
(43) Pub. Date: Jun. 8, 2023

(54) METHOD AND FORMULATION FOR ROTOMOULDING RECYCLED POLYMER AND PRODUCTS THEREOF

(71) Applicant: Pact Group Industries (ANZ) Pty Ltd, Richmond, Victoria (AU)

(72) Inventors: Graeme Hall, Richmond, Victoria (AU); Bloys Rijkmans, Richmond, Victoria (AU); Eustathios Petinakis, Richmond, Victoria (AU)

(21) Appl. No.: 17/997,995

(22) PCT Filed: May 5, 2021
(86) PCT No.: PCT/AU2021/050417

§ 371 Date: Nov. 4, 2022

(30) Foreign Application Priority Data
May 5, 2020 (AU) 2020901425

(51) Int. Cl. B29C 41/22; B29C 41/00; B29C 41/06; B29C 41/46

(52) U.S. Cl. CPC B29C 41/22; B29C 41/003; B29C 41/06; B29C 41/46; B29C 2791/002; B29K 2023/0633

(57) ABSTRACT

A rotomoulded product and a method of making a rotomoulded product via rotational moulding, the rotomoulded product including at least two layers of material that form a wall of the product, at least one of the layers including post-consumer recyclate (PCR), and at least one of the layers including virgin PE.

### TECHNICAL FIELD

The present invention relates generally to the field of recycling polymers, and more particularly, to use of recycled polymer or post-consumer recyclate (PCR) polymer in rotational moulding.

In this context, the present invention relates to a method of manufacturing a product comprising post-consumer recyclate (PCR) polymer by rotational moulding, and to a formulation for rotomoulding a product, as well as a rotomoulded product comprising PCR polymer.

### BACKGROUND

It is to be appreciated that any discussion of background art or related art in this specification, whether documents, devices, acts or knowledge, is included to explain the context of the present invention. Further, the discussion throughout this specification of background art or related art comes about due to realisations of the inventors and/or identification of certain related art problems by the inventors and it is included to explain the context of the invention in terms of the inventors' knowledge and experience. Thus, any such discussion of background art or related art is not to be taken as an admission that any of that material forms part of the prior art or the common general knowledge in the relevant art in Australia, or elsewhere, on or before the priority date of this disclosure.

Rotational moulding (also known as ‘rotomoulding’) is a high-temperature, low-pressure (low shear) plastic forming process that uses heat and biaxial rotation to produce hollow, single component parts. In essence, rotomoulding involves the use of a hollow mould that is filled with a powder or liquid material, such as polymer resin. The material is softened by heating, and the mould is then rotated, usually around two perpendicular axes, to disperse the material across the walls of the mould. The mould is rotated during heating to avoid sagging or deformation and ensure good adherence of the material to the mould walls.

Finally, the mould is cooled, typically using a fan. The plastic shrinks as it cools and separates from the walls of the mould. The cooling must be carefully controlled to avoid warping. The mould is then opened to remove the moulded product.

Rotomoulding is often used for producing large, hollow products for consumer, industrial, agricultural, or maritime use. Products include containers such as bins, liquid storage tanks, planter pots, pits, panels, and troughs. It is also useful for a diverse range of smaller products such as small fuel tanks, automotive parts, toy parts, and furniture. Rotational moulds are cheaper to manufacture and use compared with other types of plastic moulding. The process of rotomoulding can be very economical and typically very little process material is wasted.

Plastics, such as PVC plastisol, were first used in rotomoulding in the early 1950s. During the 1960s, the Engel process was developed and allowed moulding of low-density polyethylene (LDPE). In the 1980s, processes were developed for new plastics such as polycarbonate, polyester and nylon.

More than 80% of material used in rotomoulding is polyethylene (PE), including cross-linked polyethylene (PEX), low-density polyethylene (LDPE), linear low-density polyethylene (LLDPE), high-density polyethylene (HDPE). Polyvinyl chloride (PVC) plastisols, nylons, and polypropylene are also used, but less commonly than PE based plastics.

Where used herein, the term high density polyethylene (HDPE) means any thermoplastic polymer produced from the monomer ethylene and having a density of 930 kg/m³ to 970 kg/m³. HDPE typically includes PCRs such as plastic bottles, including milk bottles, suitable for recycling or re-use, plastic bags, and food storage containers.

Where used herein the term low density polyethylene (LDPE) means any thermoplastic polymer produced from the monomer ethylene and having a density of 917 kg/m³ to 930 kg/m³.

Where used herein the term linear low-density polyethylene (LLDPE) refers to a substantially linear polyethylene with significant numbers of short branches, commonly made by copolymerisation of ethylene with longer-chain olefins. Linear low-density polyethylene differs structurally from LDPE by the absence of long chain branching, is not biodegradable, and can take a long time to decompose, so there is a great deal of interest in recycling products made of LLDPE and LDPE.

LLDPE is used widely in rotomoulding due to its excellent chemical resistance, high stiffness, good processability and low cost. LLDPE is not biodegradable and can take centuries to decompose, so there is a great deal of interest in recycling products made of LLDPE.

However, compared to other plastics manufacturing processes, the number of materials suitable for rotational moulding is comparatively limited.

A number of considerations arise when choosing the type or formulation of polymeric material to be used in rotomoulding.

Firstly, due to high temperatures within the mould, the formulation must have high thermal stability to avoid degradation due to thermo-oxidative effects. In particular, the polymer formulation must have high thermal stability.

Secondly, the molten polymer contacts the oxygen rich environment inside the mould, potentially leading to oxidation and deterioration of the material's properties. Therefore, the chosen polymer formulation must be able to resist degradation.

Thirdly, because rotomoulding is a low-pressure (low shear) process, the molten plastic formulation must be able to distribute easily through the cavities of the mould.

Fourthly, the material is typically introduced into a mould in powder form.

Other requirements for the materials used successfully in rotomoulding relate to characteristics such as grindability, particle size distribution, particle shape, pourability, bulk density, thermal stability, melt flow index (MFI), shear viscosity and appropriate UV and weathering protection.

Polymers suitable as rotational moulding grade materials are generally chosen with regard to the end-use properties of the rotationally moulded product, and their suitability in this context is largely correlated with the density and MFI of the polymer feedstock.

Increasing the polymer density leads to increased rigidity and stiffness in the rotationally moulded product, higher tensile yield strength, higher softening temperature, greater surface hardness and abrasion resistance, improved chemical resistance, increased gas and liquid impermeability, and greater resistance to creep. Reducing the polymer density leads to improved impact strength in the rotationally moulded product, higher elongation at break, better environmental stress crack resistance, and lower warpage and distortion.

Increasing the MFI of the polymer leads to improvements in ease of manufacture including reduced melt viscosity, improved flow, and faster cycle time as well as better gloss in the appearance of the rotationally moulded product. Decreasing the MFI of the polymer leads to improved toughness and impact strength in the rotationally moulded product, better environmental stress crack resistance, higher tensile strength, and higher elongation at break.

Although it is not an essential requirement for producing a rotationally moulded product, polymer feedstocks for use in rotomoulding processes often benefit from the addition of additives including, but not limited to, antioxidants and/or UV inhibitors, especially where the finished product may be used in contexts such as outdoor environments or where it may be exposed to direct sunlight.

It is well known that recycling plastics creates significant environmental and economic benefits. In the past, post-industrial recyclate (PIR) has been a source of recycling feedstock but its use is limited by lack of availability. PIR includes leftovers trimmed off rotomoulded products and used products (such as poly tank rejects) that are reprocessed for reuse in rotomoulded and other multi-use products.

However, the mechanical properties of recycled material are less reliable, cannot be guaranteed, and are not typically the same as virgin material, so recycled material has typically been used for non-structural products in non-food contact applications.

Particular problems arise with reprocessing of post-consumer recyclate (PCR) polymer that includes single use items such as food containers, drink bottles, milk bottles, bottles for household detergent, garden products, and toiletries. PCR is not typically suitable for the low pressure, low shear oxygen rich environment that is typically associated with rotomoulding. Polyethylenes and polypropylenes manufactured for single use applications are the main source of PCR plastic waste. Due to the variable nature in the melt flow and possible incorrect densities associated with plastics from PCR sources, this has been found to render the recycled plastic unsuitable for rotomoulding. In addition, often, the PCR plastic waste does not include UV stabilization and/or additional antioxidant additive(s) required for long term outdoor exposure. Polypropylenes are further restricted by their poor ability to be ground into powder, the primary form required, or at least preferred, for rotational moulding.

In the past some PCR recycling has been carried out using HDPE PCR feed stocks (such as plastic milk bottles) that have a consistent MFI and density. This type of PCR plastic waste can be compounded via extrusion with rotational moulding grade LLDPEs to alter the MFI and density so that they fall within a range that is suitable for rotomoulding. By adding suitable UV stabilizers and antioxidant additive it is possible to obtain a blend suitable for many long-term applications. Although the recycled product is not as tough as virgin rotomoulding grade products, the reduction in toughness is at an acceptable level. Generally, when processing this blend the rotomoulding process is modified by a slight increase (5%) in time or temperature as compared to typical LLDPE rotomoulding.

The inventors have realised that it has hitherto proved difficult to recycle PCR polyethylenes of inconsistent or unknown MFI and density. This is typical of PCR film, wraps, and packaging materials that are discarded in domestic recycling bins. Waste polymer feedstock derived from this type of PCR polyethylene tends to have inconsistent chemical and physical characteristics, which can compromise mechanical properties and mouldability. This problem is further complicated by the fact that PCR polyethylenes of this type often have a melt flow index (MFI) and a density that are not conducive to being rotationally moulded.

There is thus a need for a formulation and/or a method for re-using or recycling PCR polyethylenes of inconsistent or unknown MFI and density.

### SUMMARY

It would be desirable to provide a new or improved method for recycling PCR polyethylenes and/or for manufacturing products made of such recyclates.

It would also be desirable to provide a process or means for increasing the amount of PCR polyethylenes that can be recycled.

It would furthermore be desirable to substantially overcome or at least alleviate one or more of the above noted drawbacks of related art systems, or at least to provide a useful alternative to related art systems.

In one broad form, the present invention provides a rotomoulded product comprising a plurality of layers that form a wall of the product, at least one layer including (preferably predominately) PCR polymer material and at least one layer including (preferably predominately) virgin polymer material. The at least one PCR polymer layer provides typical properties required of rotational moulding but may be subject to reduced mechanical properties. The at least one virgin layer then provides a layer which, when combined with the at least one PCR layer, ameliorates or improves the mechanical properties of the wall section.

In a first aspect of embodiments described herein, there is provided a rotomoulded product, and/or a method of manufacturing such a product, comprising at least two layers that form a wall of the product, at least one layer including PCR polyethylene (PE) and at least one layer including virgin polyethylene (PE). The at least one layer of or including PCR PE is preferably comprised predominantly of PCR PE, and preferably substantially entirely of PCR PE. Similarly, the at least one layer of or including virgin PE is preferably comprised predominantly of virgin PE, and preferably substantially entirely of virgin PE.

In this context, it will be appreciated that the rotomoulded product may have a generally hollow shape or configuration and the wall of the product may enclose or define that hollow shape or configuration. The wall of the rotomoulded product is formed by or is comprised of the plurality of layers.

In another aspect of embodiments described herein, there is provided a rotomoulded product, and/or a method of manufacturing such a product, comprising at least two layers that form the wall of the product, an outer layer comprised of PCR PE or virgin PE and an inner layer comprised of virgin PE or PCR PE, respectively. The virgin PE is typically a rotational moulding grade material. In some embodiments, a third layer and/or one or more subsequent layer may be provided.

The present inventors have found that the at least one layer of virgin PE in the wall of the rotomoulded product provides substantially improved mechanical properties to a wide range of multiple layer formulations that would otherwise be compromised or unsuitable from a mechanical point of view.

In an embodiment described herein there is provided a rotomoulded product, and/or a method of manufacturing such a product, comprising a first layer comprised of PCR PE and a second layer comprised of virgin PE.

In an embodiment described herein there is provided a rotomoulded product, and/or a method of manufacturing such a product, comprising a first layer comprised of virgin PE and a second layer comprised of PCR PE.

In an embodiment described herein there is provided a rotomoulded product, and/or a method of manufacturing such a product, comprising a first layer comprised of PCR PE, a second layer comprised of virgin PE, and a third layer or one or more further or subsequent layer(s) comprised of virgin PE and/or PCR PE.

In an embodiment described herein there is provided a rotomoulded product, and/or a method of manufacturing such a product, comprising a first layer comprised of virgin PE, a second layer comprised of PCR, and a third layer or subsequent layer(s) comprised of virgin PE and/or PCR. Thus, the present invention contemplates a range of multi-layered wall sections for the rotomoulded product, including: two-layered, such as: virgin PE-PCR or PCR-virgin PE; three-layered, such as: virgin PE-PCR-virgin PE or PCR-virgin PE-PCR; and four-layered, such as:

(i) virgin PE-PCR-virgin PE-PCR,

### (ii) PCR-virgin PE-PCR-virgin PE,

(iii) virgin PE-PCR-virgin PE-virgin PE,

### (iv) PCR-virgin PE-PCR-PCR, etc.

In a preferred embodiment, the rotomoulded product has a wall comprising a first layer of PCR PE having a thickness in the range of 1 mm to 12 mm, preferably 3 mm to 10 mm, and a second layer of virgin PE having a thickness in the range of 1 mm to 5 mm, preferably 2 mm to 3 mm

Where used herein, the term post-consumer recyclate (PCR) means or refers to waste created by consumers that is collected and subjected to a proprietary process to produce plastic in a form (typically powdered, granulated, or pellet) suitable for recycling. The PCR resin may be derived from any plastic, but where used herein, the preferred PCR feedstock is derived from polyethylene with no or little other contaminants present.

Preferably, the PCR is used singularly or is a blend of two or more of HDPE, LDPE and LLDPE. Other suitable materials may also be used or blended for the PCR.

Preferably, the MFI of the PCR PE blend is within the range of from 1 to 10, more preferably within the range of 3 to 5.

Typically, the combined first layer and second layer provide a wall section having a thickness within the range of 3 mm and 15 mm in the final rotomoulded product.

Rotomoulded products are used in a vast array of activities and applications, which may include products such as, without limitation, a large, hollow product such as a liquid tank, planter pot, junction pit, panel, or trough. As a consequence, the products must satisfy a vast range of requirements. For example, many rotomoulded products will be required to provide many years of service while being subject to exposure from sunlight and other environmental elements. In addition, many rotomoulded products are subject to relatively high mechanical loads. These loads can be exerted from the outside of the product, from the inside of the product, or both.

Products subjected to significant mechanical loads on the outside include those used underground, such as junction pits and noise walls. By contrast, above-ground water tanks are typically subjected to significant mechanical loads on the inside. Products subjected to loads applied to both an inner side and an outer side of the wall included in-ground water tanks, sewerage pipes and septic tanks.

Alternatively, the rotomoulded products may be smaller products such as fuel tanks, automotive parts, doll parts, sporting balls, furniture, waste storage containers, refuse collection bins, rubbish chutes, agriculture and aquaculture systems and/or parts thereof.

In a preferred embodiment, the rotomoulded product of the invention may be a plastic panel of the type used in sound attenuation barriers or other wall structures. For example, the product may be a rotomoulded sound absorptive panel mounted in a sound panel or steel structure. A panel of this type is disclosed and described in Australian patent application no. 2019202436 in the name of Pact Group Industries (ANZ) Pty Ltd.

According to another aspect, the present invention provides a formulation, and particularly a blending of components including various sources of PCR polyethylene to form a feed stock that can be rotationally moulded.

In another aspect of embodiments described herein, there is thus provided a formulation for rotomoulding a product, the formulation comprising a first PCR PE component comprising a HDPE, LDPE and/or LLDPE, either singularly or as a blend of at least two of the afore-mentioned, for forming a first rotomoulded PCR layer, and a second component comprising virgin PE for forming a second rotomoulded virgin PE layer, wherein the first PCR and second virgin PE rotomoulded layers form a monolithic rotomoulded wall of the product.

In a further aspect of embodiments described herein, there is provided a formulation for rotomoulding a product, the formulation comprising a first component comprising virgin PE for forming a first rotomoulded virgin PE layer, and a second PCR PE component comprising a HDPE, LDPE, and/or LLDPE, either singularly or as a blend of at least two of the afore-mentioned, for forming a second rotomoulded PCR layer, wherein the first virgin PE and the second PCR rotomoulded layers form a monolithic rotomoulded wall of the product.

In a preferred embodiment, the PCR layer comprises between 0 and 100 wt % more preferably 100 wt % of LLDPE.

In a preferred embodiment, the PCR layer comprises between 60 and 90 wt % more preferably 65 to 85 wt % of LLDPE.

In a preferred embodiment the PCR layer comprises between 10 and 60 wt %, more preferably 15 to 50 wt % of LDPE.

In a preferred embodiment, the PCR layer comprises between 15 and 50 wt % more preferably 15 to 30 wt % of LDPE.

In a preferred embodiment, the PCR layer comprises between 45 and 85 wt %, preferably 50 and 80 wt %, more preferably 60 to 70 wt % of HDPE.

In a preferred embodiment, the PCR layer comprises any one of or any combination of HDPE, LLDPE and LDPE.

Table 1 below illustrates exemplary embodiments of the present invention.

In a preferred embodiment, the PCR layer comprises HDPE and LDPE in a ratio of 70:30, or alternatively in a ratio of 60:40, and more preferably in a ratio of 50:50.

Preferably, the MFI of the PCR PE blend is within a range of 1 to 10 MFI, and more preferably in the range of 3 to 5 MFI.

Preferably, the density of the PCR is in a range of about 930 to 970 kg/m³.

The PCR polyethylene blend may include one or more suitable additives, such as a UV stabilizer or an antioxidant, as is known in the art. In particular, this may assist to ensure that an outermost (first) layer comprising the PCR PE has the same weathering characteristics as traditional rotomoulded products. Where these properties are desirable in the finished product, an appropriate combination of chemical additives (known as an ‘additives package’) may be used with the PCR.

In another aspect of embodiments described herein there is provided a method for manufacturing a product by rotational moulding, the method including steps of:

(a) adding to a cavity of a mould, a predetermined amount of PCR material, such as a PCR PE, preferably singularly or as a blend formed from a combination of at least two of HDPE, LDPE and LLDPE;
(b) heating the mould whilst rotating the mould (preferably biaxially) until the PCR material adheres and forms a first layer on an internal surface of the mould;
(c) adding to the mould, a predetermined amount of virgin PE material;
(d) continuing to heat the mould with rotation (e.g., biaxial) until the virgin PE melts and forms a second layer adhering to the first layer;
(e) cooling the mould until the first layer and the second layer solidify to form a monolithic wall of the product;
(f) removing the product from the cavity of the cooled mould.

In another aspect of embodiments described herein there is provided a method for manufacturing a product by rotational moulding, including steps of:

(a) adding to a cavity of a mould, a predetermined amount of virgin PE material;
(b) heating the mould whilst rotating (e.g., biaxially) until the virgin PE material melts and forms a first layer adhering to an internal surface of the mould;
(c) adding to the cavity of the mould, a predetermined amount of PCR material comprising a PCR PE;
(d) heating the mould whilst rotating biaxially until the PCR material melts and forms a second layer adhered to the first virgin PE layer in the mould;
(e) cooling the mould until the first virgin PE layer and second PCR layer solidify to form a monolithic wall of the product;
(f) removing the product from the cavity of the cooled mould.

In a further aspect of embodiments described herein there is provided a method for manufacturing a product by rotational moulding including the steps of:

(a) adding to a cavity of a mould, a predetermined amount of virgin PE material;
(b) heating the mould whilst rotating biaxially until the virgin PE material melts and forms a first virgin PE layer adhering to an internal surface of the mould;
(c) adding to the mould, a predetermined amount of PCR material comprising a PCR PE;
(d) heating the mould whilst rotating (optionally) biaxially until the PCR material fuses/adheres and forms a second PCR layer adhered to the first virgin PE layer in the mould;
(e) adding to the mould, a predetermined amount of virgin PE material;
(f) continuing to heat the mould with biaxial rotation until the virgin PE material melts and forms a subsequent virgin PE layer adhering to the second PCR layer;
(g) cooling the mould until all layers solidify to form a monolithic wall of the product;
(h) removing the product from the cavity of the cooled mould.

In yet another aspect of embodiments described herein there is provided a method for manufacturing a product by rotational moulding including the steps of:

(a) adding to a cavity of a mould, a predetermined amount of PCR PE material;
(b) heating the mould whilst rotating biaxially until the PCR material melts and forms a first PCR layer adhering to an internal surface of the mould;
(c) adding to the mould, a predetermined amount of virgin PE material;
(d) heating the mould whilst rotating the mould until the virgin PE material adheres and forms a second virgin PE layer adhered to the first PCR layer in the mould;
(e) adding to the mould, a predetermined amount of PCR PE material;
(f) continuing to heat the mould with biaxial rotation until the PCR material melts and forms a subsequent PCR layer adhering to the second virgin PE layer;
(g) cooling the mould until all layers solidify to form a monolithic wall of the product;
(h) removing the product from the cavity of the cooled mould.

In yet a further aspect of embodiments described herein, there is provided a method for manufacturing a product by rotational moulding, and/or a formulation for such a product, further including more layers in the moulding process. The steps (e) and (f) in either of the penultimate or final sets of method steps listed above may be repeated in order to incorporate more layers, the layers being of any selected material, such as virgin PE and/or PCR PE. The further layers may result in a moulded product having multiple layered materials.

Other aspects and preferred forms of a rotomoulded product and method of manufacturing same are disclosed in this description and/or are defined in the appended claims, forming a part of the specification of the invention.

To recycle PCR polyethylenes of variable or unknown MFI and density would require blending such that the resulting MFI and density of the blend is in a range that may be usefully and reliably rotationally moulded. However, as a person skilled in the art will appreciate, although the blend may be capable of being rotomoulded, the resulting product may nevertheless have poor mechanical properties. In essence, embodiments of the invention stem from the realisation that overcoming the poor mechanical properties typical with PCR increases the opportunity to recycle high levels of PCR.

More particularly, the invention stems from a realisation that rotomoulding can be used to create a product with a relatively high-density outer layer of PCR polyethylene combined with a relatively thin inner layer of virgin LLDPE. In this way, the inventors have found that the product has the benefit of the stiffness of the HDPE in combination with the toughness of LLDPE. This approach can be used to enhance the mechanical properties of any combination of PCR blends. Without wishing to be bound by theory, the LLDPE virgin layer acts as a bonding agent giving the blend the mechanical properties needed for long-term applications.

Further, the invention stems from a realisation that rotational moulding can be used to mould a product including various ingredients. Rotational moulding starts with introducing a known amount of plastic (e.g., PCR) in powder, granular, or viscous liquid form into a hollow, shell-like mould. The mould is rotated and/or rocked (usually) about two principal axes at relatively low speeds as it is heated so that the plastic enclosed in the mould adheres to and forms a somewhat consistent and/or monolithic layer against the mould surface. Mould rotation continues during a cooling phase so that the first layer of plastic retains a desired shape and starts to solidify. The introduction of a second material layer is delayed until the PCR recycled layer has adhered to the mould surface. Once this has occurred, the second material is introduced and it then fuses with and/or adheres to and becomes part of the monolithic layer. The introduction of any subsequent third or more layer(s) may also be delayed until the previous layer has fused with and/or adhered to the earlier introduced layer and becomes a part of the monolithic layer in the mould.

After all of the layers of polymer material have been added and combined, the mould rotation continues during the cooling phase so that the plastic retains its desired shape as it solidifies. When the plastic is sufficiently rigid, the cooling and mould rotation is stopped to allow the removal of the plastic product from the mould. At this stage, the cyclic process may be repeated. The basic steps of (a) mould charging, (b) mould heating, (c) mould cooling, (d) subsequent mould charging, (e) mould cooling, (f) repeating steps (d) and (e) if necessary, and (g) part ejection.

The present invention may be applied to at least one or any combination of the following:

Provision of an expanded opportunity for recycling waste material;

Rotomoulded products are widely used in the expanding infrastructure sector, which creates large opportunities for use of PCR materials;

Use of other materials as the virgin layer to gain other properties that may be useful to the finished product. For example, crosslinked PE;

The PCR layer and the virgin layer can be different colours;

PCR materials may be problematic when used for food and/or water contact applications but the use of the virgin layer makes the use possible as the PCR layer need not be in contact with the food and/or water;

A variety of product structures, formulations and methods of manufacture, such as Virgin/PCR, PCR/Virgin, Virgin/PCR/Virgin, PCR/Virgin/PCR, plus a further layer or 2, 3 or more further layers of Virgin and/or PCR.

Further scope of applicability of embodiments will become apparent from the detailed description provided in the following. However, it should be understood that the detailed description and specific examples, while indicating preferred embodiments, are given by way of illustration only, as various changes and modifications within the scope of the disclosure herein will become apparent to those skilled in the art from this detailed description.

### BRIEF DESCRIPTION OF THE FIGURES

Further disclosures, objects, and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates a method of manufacturing a product by rotational moulding according to an embodiment of the invention, and

FIG. 2 illustrates a method of manufacturing a product by rotational moulding according to another embodiment of the invention.

### DETAILED DESCRIPTION

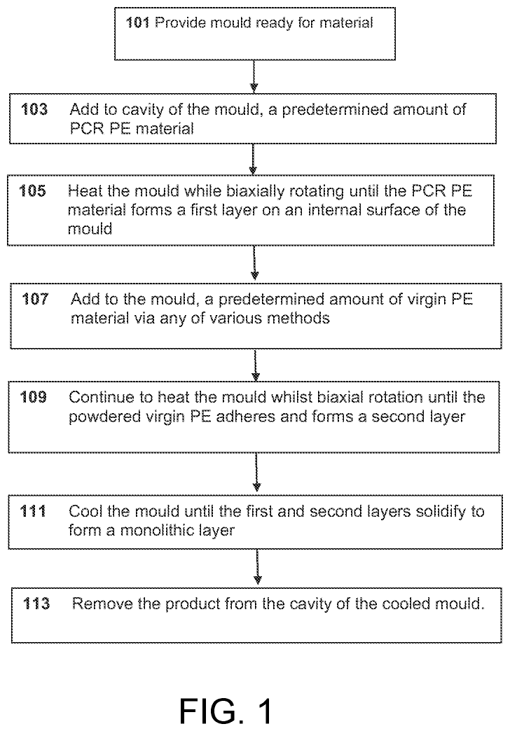

FIG. 1 of the drawings depicts steps involved in a method of manufacturing a product by rotational moulding according to one embodiment of the present invention. Multilayer rotomoulding has been known for many years. Generally, in rotomoulding a mould is provided that can be opened to reveal a cavity (101). The mould is typically a separable cast, machined, or fabricated mould. A predetermined amount of material comprising PCR PE, preferably in powdered, granular or pellet form, is introduced or placed into the cavity of one part of the mould (103) and the mould is then closed. The mould is heated to a required processing temperature (105), usually whilst rotating the mould biaxially. In this regard, the mould may be heated in an oven without applying pressure or centrifugal force. Heat is transferred through the mould wall causing the PCR PE material to melt and adhere to form a first layer on an internal surface of the mould (105).

A predetermined amount of virgin PE, again preferably in powdered, granular or pellet form, is then added to the mould (107). This may be achieved by a variety of methods, such as:

Method 1—Removing the mould from the heat source and pouring the virgin PE material into the mould via fill port using gravity or dense phase conveyance; or

Method 2—Without interrupting the process, discharging the virgin PE material in powdered/granular form from a holding vessel (known as a ‘dropbox”) via a mechanically activated fill port, e.g., allowing the PE to discharge into the mould under gravity. The virgin PE material is substantially prevented from heating prior to its discharge by thermally insulating the dropbox;

Method 3—Whilst maintaining heating but stopping the biaxial rotation, feeding the (powdered) virgin PE material into the mould via a feeding lance entering the mould through a fill port and discharging via gravity or dense phase conveyance.

Other methods, including any other means known in the art for creating multiple layers during rotomoulding. For example, multiple layers can be prepared by the manual introduction of material during the moulding process, or by use of a drop-box. Manual addition involves moving the mould from the oven, removing a vent tube or plug that creates an opening in the part providing access to the mould cavity and adding more material using, for example, a funnel. By contrast a drop-box typically contains a single material layer and it is an insulated container that holds material until it is released at the appropriate time during the process. The signal for release of material is usually transmitted as a pressure pulse via an airline through an arm of the rotomoulding machine. The dropbox must be kept cool to prevent the material inside the box from melting. A feeding tube may be used with the assistance of gravity or pressure.

The mould is then heated at the required processing temperature (109) whilst rotating the mould biaxially. In this regard, there are two notable factors:

(1) the temperature at which the second or subsequent layer is added: it is important for determining the wall thickness of the previous layer formed and how well the two layers may fuse, bond or be bound together; and
(2) the time elapsed before addition of the second or subsequent layer of material: if the mould is at rest for too long, the material that has already adhered to the wall may sag.

The mould continues to be heated with biaxial rotation until the virgin PE layer adheres to the PCR layer and forms a second layer adhering to the first layer (109).

After the layers have formed, heating is ceased and the mould is cooled, for example, by moving the mould out of the oven while biaxial rotation continues. Still air, moving air from a fan, or water are typically used to cool the mould and start solidification of the two layers forming the product (111). Once the product inside the mould has cooled to a state of sufficient rigidity the mould is opened and the product is removed from the cavity of the mould (113).

A rotomoulded PCR products can have poor mechanical properties for various reasons. These may include, for example, poor sintering due to under-curing or damage to the polymer structure due to over-curing, poor quality feedstock material, and/or lack of processing additives, such as antioxidants or stabilizers. Poor mechanical properties may manifest as any one or more of multiple void spaces (high porosity) within a wall section of the product, an uneven inner surface, and/or possible formation of voids which can lend themselves to forming crack initiators from which cracks may, in turn, propagate and become visible on the surface of the moulded product.

Without wishing to be bound by theory, it is believed that the virgin inner layer of the above embodiment inhibits crack propagation. Loads applied primarily against the outer layer are protected by the inner layer, and loads applied against the inner layer (which alone might be compromised) are, in turn, supported by the outer layer. The inner layer is thus particularly important at that part of the wall at which the load is expected to be applied.

Polymers will degrade over time, particularly when located outdoors. Polymer stabilisation additives are thus added in order to slow onset of degradation. Antioxidants are used to protect the polymer from thermal degradation due to the moulding process as well as due to heat from the sun. UV stabilisers function to protect the polymer from photo-oxidation through combined exposure to sunlight and the effect of oxygen.

Polyethylene from post-consumer sources has a similar polymer structure to virgin PE used in the manufacture of many rotomoulded products used in agricultural, industrial, automotive and marine applications. This means that such products are required to have long term durability and performance that is appropriate for their end use. One of the main differences between PCR polyethylene and traditional rotomoulding polyethylene grades, however, is that PCR PE products are often created for single use, disposable applications and therefore may not need to be stabilised against the kind of thermal or UV degradation caused by years of outdoor exposure. As noted above, a rotomoulding grade PE will usually contain one or more specially designed stabilisers and/or other additives to protect the final rotomoulded product and make it suitable for use in an outdoor environment for the extent of its service life (e.g., years or even decades). For this reason, in order to ensure that the PCR PE has the same weathering characteristics as traditional rotomoulded products, an appropriate combination of chemical additives (known as an ‘additives package’) is desirably be used. This additive package is melt-compounded into the PCR PE to ensure complete distribution of the protective additives, throughout the PCR PE to form a well stabilized PCR PE.

The PCR PE may be selected, depending on the type of feedstock needed, to provide recycled feedstock material which substantially does not contain contaminants of other polymer types which could adversely affect performance. Stabilisation agents will need to be added typically in the melt-compound process. The rotomoulding PE grade consumed may contain additives providing an elevated level of UV protection to provide even further protection to the final PCR PE moulded product against the elements.

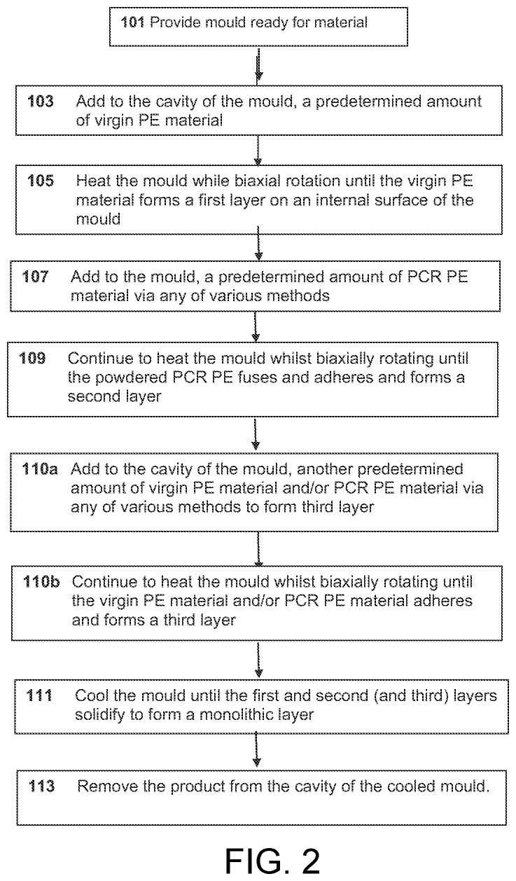

FIG. 2 of the drawings depicts steps involved in a method of manufacturing a product according to another embodiment of the invention. Multilayer rotomoulding has been known for many years. Generally, in rotomoulding a mould is provided that can be opened to reveal a cavity (101). The mould is typically a separable cast, machined or fabricated mould. A predetermined amount of material comprising virgin PE, preferably in powdered, granular, or pellet form, is placed in the cavity of one part of the mould (103) and the mould is then closed. The mould is then heated to the required processing temperature (105), whilst rotating the mould biaxially. The mould is typically heated in an oven without applying pressure or centrifugal force. Heat is transferred to the PE material through the mould causing the virgin PE material to melt and adhere to form a first layer on an internal surface of the mould (105).

A predetermined amount of PCR PE, again preferably in a powdered, granular or pellet form, is then added to the mould (107) for forming a second layer. This may be achieved by various methods such as:

Method 1—Removing the mould from the heat source and pouring the PCR PE material into the mould via fill port using gravity or dense phase conveyance; or

Method 2—Without interrupting the process, discharging the PCR PE material in powdered/granular form from a holding vessel (known as a ‘dropbox’) into the mould under gravity via a mechanically activated fill port. The PCR PE material is substantially prevented from heating prior to discharge by thermally insulating the dropbox;

Method 3—Whilst maintaining heating but stopping the biaxial rotation, feeding the (powdered or granular) PCR PE material into the mould via a feeding lance entering the mould through a fill port and discharging via gravity or dense phase conveyance.

Other methods, including any other means known in the art for creating multiple layers during rotomoulding. For example, multiple layers can be prepared by the manual introduction of material during the moulding process, or by use of a drop-box. Manual addition involves moving the mould from the oven, removing a vent tube or plug that creates an opening in the part providing access to the mould cavity and adding more material using, for example, a funnel. By contrast, a drop-box typically contains a single material layer and it is an insulated container that holds material until it is released at the appropriate time during the process. The signal for release of material is usually transmitted as a pressure pulse via an airline through an arm of the rotomoulding machine. The dropbox must be kept cool to prevent the material inside the box from melting. A feeding tube may be used with the assistance of gravity or pressure.

The mould is then heated at the required processing temperature (109) whilst rotating the mould biaxially until the second PCR layer fuses or adheres to the first virgin PE layer. In this regard, there are two notable factors:

(1) the temperature at which the second or subsequent layer is added: it is important for determining the wall thickness of the previous layer formed and how well the two layers may fuse or be bound together; and
(2) the time elapsed before addition of the second or subsequent layer of material: if the mould is at rest for too long, the material that has already adhered to the wall may sag.

A predetermined amount of material comprising virgin PE, e.g., in a powdered, granular or pellet form, is added to the mould (110a) in order to form a third layer. The mould is then heated again, whilst rotating the mould biaxially at the required processing temperature (110b). The mould is typically heated in an oven without applying pressure or centrifugal force. Further layers can be added by repeating steps 110a and 110b with virgin PE material and/or PCR PE material. Heat is transferred through the mould wall causing the PE material (in powdered, granular or pellet form) to melt and fuse or adhere to the second layer and form a third layer on an internal surface of the mould (110b).

After the layers have formed, heating is ceased and the mould is cooled, for example, by moving the mould out of the oven while biaxial rotation continues. Still air, moving air from a fan, or water are typically used to cool the mould and start solidification of the layers forming the product (111). Once the product inside the mould has cooled to a state of sufficient rigidity the mould is opened and the product is removed from the cavity of the mould (113).

### Examples

The present invention will be further described with reference to the following non-limiting example of PCR formulations suitable for use in the first, outer layer of the present rotomoulding invention.

Table 1 lists thirteen PCR formulations for use in a PCR layer in a rotomoulded product according to the present invention. Each comprises at least one LLDPE or two of HDPE, LDPE and LLDPE. The thirteen formulations were devised to be used in the rotomoulding method described with reference to FIG. 1 or FIG. 2 to form the PCR PE layer(s). Other layer(s) comprise virgin PE. One preferred result is provided by the Formulation 9—a 50:50 blend of HDPE and LDPE.

In general, the PCR PE material should be designated by PE type, MFI, and density and is derived from sources such as garbage and waste collection bins and is of relatively consistent composition. The PCR material comprises many different types of PCR PE material from a wide range of sources and the composition varies.

In Table 1, below, the following abbreviations are used:

LLDPE—Linear low-density polyethylene

HDPE—High-density polyethylene

LDPE—Low-density polyethylene

PCR PE—Post Consumer Recyclate polyethylene

MFI is measured at 2.16 kg at 190° C. (See standards ASTM D1238 and ISO 1133)

Density is measured in kg/m³

TABLE 1

| Recycle Blend Options | | | | |
|---|---|---|---|---|
| Formulation | PCR PE | Density | MFI | Ratio |
| 1 | LLDPE | 938 | 3 | 100 |
| 2 | LDPE | 923 | 2 | 70 |
| | LDPE | 922 | 0.3 | 30 |
| | LDPE | 923 | 1.1 | 100 |
| 3 | LLDPE | 938 | 3 | 70 |
| | LDPE | 922 | 0.3 | 30 |
| | LLDPE/LDPE | 933 | 1.5 | 100 |
| 4 | LLDPE | 938 | 3 | 85 |
| | LDPE | 922 | 0.3 | 15 |
| | LLDPE/LDPE | 935 | 2.1 | 100 |
| 5 | HDPE | 956 | 7 | 70 |
| | LDPE | 922 | 0.3 | 30 |
| | HDPE/LDPE | 945 | 2.7 | 100 |
| 6 | HDPE | 956 | 7 | 60 |
| | LDPE | 922 | 0.3 | 40 |
| | HDPE/LDPE | 942 | 2 | 100 |
| 7 | HDPE | 956 | 7 | 70 |
| | LDPE | 923 | 1.1 | 30 |
| | HDPE/LDPE | 946 | 4 | 100 |
| 8 | HDPE | 956 | 7 | 60 |
| | LDPE | 923 | 1.1 | 40 |
| | HDPE/LDPE | 942 | 3.4 | 100 |
| 9 | HDPE | 956 | 7 | 50 |
| | LDPE | 923 | 1.1 | 50 |
| | HDPE/LDPE | 939 | 2.8 | 100 |
| 10 | HDPE | 956 | 7 | 50 |
| | LDPE | 922 | 0.3 | 50 |
| | HDPE/LDPE | 939 | 1.5 | 100 |
| 11 | HDPE | 955 | 4.5 | 50 |
| | LDPE | 922 | 0.3 | 50 |
| | HDPE/LDPE | 939 | 1.16 | 100 |
| 12 | HDPE | 955 | 4 | 50 |
| | LDPE | 922 | 0.3 | 50 |
| | HDPE/LDPE | 939 | 1.1 | 100 |
| 13 | HDPE | 956 | 10 | 50 |
| | LDPE | 922 | 0.3 | 50 |
| | HDPE/LDPE | 939 | 1.73 | 100 |

While this invention has been described in connection with specific embodiments thereof, it will be understood that it is capable of further modification(s). This application is intended to cover any variations, uses, or adaptations of the invention following in general, the principles of the invention and including such departures from the present disclosure as come within known or customary practice within the art to which the invention pertains and as may be applied to the essential features hereinbefore set forth.

Although specific embodiments of the invention are illustrated and described herein, it will be appreciated by persons skilled in the art that a variety of alternative and/or equivalent implementations exist. It should be appreciated that the exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

Thus, various modifications and equivalent arrangements are intended to be included within the scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

Throughout this specification, unless the context requires otherwise, the terms “comprise”, “comprising”, “include”, “including”, “contain”, “containing”, “have”, “having”, and variations thereof, are intended to be understood in an inclusive (i.e. non-exclusive) sense so as to imply the inclusion of a stated step, integer, feature, or element, or group of steps, integers, features, or elements but not the exclusion of any other step, integer, feature, or element, or group of steps, integers, features, or elements.

1. A rotomoulded product comprising at least two layers of material that form a wall of the product, a first layer of the at least two layers of material comprising PCR PE and a second layer of the at least two layers comprising virgin PE.

2. The rotomoulded product as claimed in claim 1, wherein the first layer and second layer are fused or combined in a monolithic wall structure.

3. The rotomoulded product as claimed in claim 2, comprising a third or subsequent layer(s), wherein the third or subsequent layer(s) is/are comprised of virgin PE and/or PCR PE.

4. The rotomoulded product as claimed in claim 2, wherein the product is a multilayered product.

5. A rotomoulded product comprising:
a first, outermost layer comprised of PCR PE; and
a second inner layer comprised of virgin PE; and optionally
a third or subsequent inner layer(s) comprised of virgin PE and/or PCR PE.

6. The rotomoulded product as claimed in claim 1, wherein the PCR PE layer has a thickness in the range of 1 mm to 12 mm, and wherein the virgin PE layer has a thickness in the range of 1 mm to 5 mm.

7. A formulation for rotomoulding a product, the formulation comprising:
a first component comprising PCR PE for forming a first layer of the rotomoulded product and a second component comprising virgin PE for forming a second layer of the rotomoulded product; or
a first component comprising virgin PE for forming a first layer of the rotomoulded product and a second component comprising PCR PE for forming a second layer of the rotomoulded product;
wherein the first layer and the second layer together form a monolithic wall in the rotomoulded product.

8. The formulation for rotomoulding the product as claimed in claim 7, the formulation comprising a third component comprising virgin PE and/or PCR PE for forming a third or subsequent layer(s) of the rotomoulded product;
wherein the first layer, second layer, third layer or subsequent rotomoulded layers together form a monolithic rotomoulded wall of the product.

9. The formulation as claimed in claim 7, wherein each PCR PE component comprises a singular LLDPE or blend of at least two of HDPE, LDPE and LLDPE.

10. The formulation as claimed in claim 7, wherein each PCR PE component and/or each virgin PE component has one or more additives selected from one or more UV stabilizers and one or more antioxidants.

11. A method of manufacturing a product by rotational moulding, the method including steps of:
(a) adding to a cavity of a mould, a predetermined amount of PCR material comprising a PCR PE;
(b) heating the mould whilst rotating the mould until the PCR material adheres and forms a first layer on an internal surface of the mould;
(c) after forming the first layer on the internal surface of the mould, adding to the mould, a predetermined amount of virgin PE material;
(d) continuing to heat the mould whilst rotating the mould until the virgin PE forms a second layer fusing and/or adhering to the first PCR layer;
(e) cooling the mould until the first PCR layer and second virgin PE layer solidify to form a monolithic wall of the product; and
(f) removing the product from the cavity of the cooled mould.

12. A method of manufacturing a product by rotational moulding, the method including steps of:
(a) adding to a cavity of a mould, a predetermined amount of virgin PE material;
(b) heating the mould and rotating the mould until the virgin PE material forms a first layer adhering to an internal surface of the mould;
(c) after forming the first layer on the internal surface of the mould, adding to the cavity of the mould, a predetermined amount of PCR material comprising a PCR PE;
(d) heating the mould and rotating the mould until the PCR material adheres and forms a second layer fused and/or adhered to the first layer in the mould;
(e) cooling the mould until the first layer and second layer solidify to form a monolithic wall of the product; and
(f) removing the product from the cavity of the cooled mould.

13. A method of manufacturing a product by rotational moulding, the method including the steps of:
(a) adding to a cavity of a mould, a predetermined amount of virgin PE material;
(b) heating the mould whilst rotating biaxially until the virgin PE material melts and forms a first virgin PE layer adhering to an internal surface of the mould;
(c) after forming the first virgin PE layer on the internal surface of the mould, adding to the mould, a predetermined amount of PCR material comprising a PCR PE;
(d) heating the mould whilst rotating biaxially until the PCR material adheres and forms a second PCR layer adhered to the first virgin PE layer in the mould;
(e) after forming the second PCR layer, adding to the mould, a predetermined amount of virgin PE material;
(f) continuing to heat the mould with biaxial rotation until the virgin PE material melts and forms a subsequent virgin PE layer adhering to the second PCR layer;
(g) cooling the mould until all layers solidify to form a monolithic wall of the product; and
(h) removing the product from the cavity of the cooled mould.

14. A method of manufacturing a product by rotational moulding, the method including steps of:
(a) adding to a cavity of a mould, a predetermined amount of PCR material comprising a PCR PE;
(b) heating the mould whilst rotating the mould until the PCR material forms a first PCR layer adhering to an internal surface of the mould;
(c) after forming the first PCR layer on the internal surface of the mould, adding to the mould, a predetermined amount of virgin PE material;
(d) heating the mould whilst rotating until the virgin PE material forms a second layer fused/adhered to the first PCR layer in the mould;
(e) after forming the fused second layer, adding to the mould, a predetermined amount of PCR material comprising a PCR PE;
(f) continuing to heat the mould with rotation until the PCR material forms a subsequent PCR layer adhering to the second virgin PE layer;
(g) cooling the mould until all of the layers solidify to form a monolithic wall of the product; and
(h) removing the product from the cavity of the cooled mould.

15. The method as claimed in claim 11, wherein the PCR material is a singular LLDPE or a blend formed from a combination of at least two of HDPE, LDPE and/or LLDPE.

16. The method as claimed in claim 13, wherein further layers are formed by repeating steps (e) and (f) with virgin PE and/or PCR PE materials, as required.

17. The rotomoulded product of claim 6, wherein the PCR layer has a thickness in the range of 3 mm to 10 mm.

18. The rotomoulded product of claim 6, wherein the virgin PE layer has a thickness in the range of 2 mm to 3 mm.
